(19) United States
(12) Patent Application Publication
(10) Pub. No.: US 2013/0264894 A1
(43) Pub. Date: Oct. 10, 2013

(54) AMORPHOUS MAGNETIC COMPONENT, ELECTRIC MOTOR USING SAME AND METHOD FOR MANUFACTURING SAME

(71) Applicant: AMOTECH CO., LTD., Incheon (KR)

(72) Inventor: Byoung Soo KIM, Anyang-si (KR)

(73) Assignee: AMOTECH CO., LTD., Incheon (KR)

(21) Appl. No.: 13/906,408

(22) Filed: May 31, 2013

Related U.S. Application Data
(63) Continuation of application No. PCT/KR2011/009578, filed on Dec. 13, 2011.

(30) Foreign Application Priority Data
Dec. 13, 2010 (KR) 10-2010-0126673

(51) Int. Cl. H01F 1/153; H02K 1/02; H01F 41/02

(52) U.S. Cl. CPC H01F 1/153; H01F 41/02; H02K 1/02
USPC 310/44; 419/32; 419/10; 148/304

(57) ABSTRACT

An amorphous magnetic component for use in a high-power, high-speed electric motor, in which amorphous metal materials are powdered, compressed, and molded, to be easily molded into magnetic components of a complex shape, and crystalline metal powder of excellent soft magnetic properties is added to the amorphous alloy powder, to promote improvement of a magnetic permeability and improvement of a packing density at the time of compression molding. A method of manufacturing the amorphous magnetic component; includes the steps of: pulverizing ribbons or strips of amorphous alloys to obtain plate-shaped amorphous alloy powder; classifying the amorphous alloy powder, and mixing the amorphous alloy powder with spherical soft magnetic powder, in order to improve magnetic permeability and packing density, to obtain mixed powder; mixing the mixed powder with a binder, to be molded into a shape of the magnetic components; and sintering the molded magnetic components to implement magnetic properties.

### TECHNICAL FIELD

The present invention relates to an amorphous magnetic component, an electric motor using the amorphous magnetic component, and a method of manufacturing the amorphous magnetic component, and more specifically, to an amorphous magnetic component for use in a high-power, high-speed electric motor, in which amorphous metal materials are powdered, compressed, and molded, to thus be easily molded into magnetic components of a complex shape, and crystalline metal powder of excellent soft magnetic properties is added to the amorphous alloy powder, to thus promote improvement of a magnetic permeability and improvement of a packing density at the time of compression molding, and a method of manufacturing the amorphous magnetic component.

In addition, the present invention relates to a high-power, high-speed electric motor having the number of poles that operate in a frequency band of at least 10 kHz or higher so that permeability properties of amorphous alloy materials can be used at maximum.

### BACKGROUND ART

The slotted stators cause difficult windings, require a lot of time on winding operations, and require complex and expensive coil winding equipment. Also, a structure formed of a number of teeth induces a magnetic discontinuity, to thus affect the efficiency of a motor, and generate a cogging torque depending on the presence of slots. In the case of a material such as an electric steel plate, the thickness of the electric steel plate is thick, to accordingly increase an iron loss, and exhibit the low efficiency in high-speed motors.

Many of devices that are being used in a variety of fields, including the latest technology of high-speed machine tools, air motors, actuators, and compressors, require electric motors exceeding 15,000 to 20,000 rpm, and, in some cases, electric motors that may operate at high speed up to 100,000 rpm. Almost all of the high-speed electric devices are manufactured to have a low magnetic polarity factor. This is to ensure to prevent magnetic bodies in electric devices that operate at high frequencies from having an overly excessive core loss. The main cause is due to the fact that soft magnetic bodies used in most of the motors are composed of Si—Fe alloys. In conventional Si—Fe-based materials, a loss caused by a changing magnetic field at a frequency of about 400 Hz or more may heat the Si—Fe-based materials until the materials cannot be often cooled by even any suitable cooling devices.

Until now, it has been known that it is very difficult to provide electric devices that are easily manufactured while taking the advantages of low-loss materials, at a low-cost. Most of attempts of applying the low-loss materials in the conventional devices have failed. This was due to the reason why the initial designs relied on simple replacement in which conventional alloys such as Si—Fe were replaced by new soft magnetic substances such as amorphous metal, in the magnetic cores of the devices. These electric devices show improved efficiency with low losses, from time to time, but may raise problems of causing a severe deterioration of the output, and big costs related to the handling such as molding of amorphous metal. As a result, commercial success or market entry did not occur.

Meanwhile, the electric motor typically includes a magnetic member formed of a plurality of stacked laminates of non-oriented electric steel plates. Each laminate is typically formed by stamping, punching, or cutting mechanically soft non-oriented electric steel pates in a desired shape. The thus-formed laminates are sequentially stacked to form a rotor or stator having a desired form.

When compared with the non-oriented electric steel plates, an amorphous metal provides excellent magnetic performance, but has been considered for a long time that it is unsuitable to be used as a bulk magnetic member such as a rotor or stator for electric motors, because of certain physical properties and obstacles that occur at the time of fabrication.

For example, the amorphous metal is thinner and lighter than the non-oriented electric steel plate, and thus a fabrication tool and die will wear more rapidly. When compared with the conventional technology such as punching or stamping, fabrication of the bulk amorphous metal magnetic member has no commercialized competitiveness due to an increase in fabrication costs for the tools and dies. Thin amorphous metal also leads to an increase in the number of the laminates in the assembled member, and also increases the overall cost of the amorphous metal rotor or stator magnet assembly.

The amorphous metal is supplied in a thin, continuous ribbon having a uniform ribbon width. However, the amorphous metal is a very mild material, and thus it is very difficult to cut or mold the amorphous metal. If the amorphous metal is annealed in order to obtain the peak magnetic characteristics, an amorphous metal ribbon is noticeably brittle. This makes it difficult to use conventional methods to configure the bulk amorphous magnetic member, and also leads to a rise in the cost. In addition, embrittlement of the amorphous metal ribbon may bring concerns about the durability of the bulk magnetic member in an application for an electric motor.

From this viewpoint, Korean Patent Laid-open Publication No. 2002-63604 proposed a low-loss amorphous metal magnetic component having a polyhedral shape and a large number of amorphous strip layers for use in high efficiency electric motors. The magnetic component may operate in a frequency range of about 50 Hz to about 20,000 Hz, while having a core loss so as to indicate the enhanced performance characteristics in comparison with the Si—Fe magnetic component that operates in the same frequency range, and has a structure that is formed by cutting an amorphous metal strip to then be formed into a plurality of cut strips having a predetermined length and laminating the cut strips using epoxy in order to form a polyhedral shape.

However, the Korean Patent Laid-open Publication No. 2002-63604 is still manufactured via a molding process such as cutting of brittle amorphous metal ribbon, and thus it is difficult to make a practical application.

Meanwhile, electric motor vehicles are classified into pure electric motor cars that drive motors by using only electric energy stored in a rechargeable battery, solar battery motor cars that drive motors by using a solar battery, fuel battery motor cars that drive motors by using a fuel battery using a hydrogen fuel, and hybrid motor cars using a combination of an engine and a motor that drive engines by using fossil fuels and drive motors by using electricity.

The conventional electric motor cars adopt a driving system in which a single rotating shaft of a motor is directly connected to a wheel to deliver the power of the motor to the wheel, or a driving system of an in-wheel motor structure of directly delivering power to a wheel by a motor that is placed inside a wheel rim. In particular, since a driving and power transmission device such as an engine, a transmission, or differential gears may be omitted in the case of adopting the in-wheel motor, weight of the motor cars may be reduced and an energy loss may be reduced in a power transmission process.

Meanwhile, in the case that a high-speed motor of a high output of 100 kW and 50,000 rpm is implemented using silicon steel plates as in drive motors for electric vehicles, an eddy current increases due to high-speed rotation, and thus a problem of generating heat may occur. Also, since the drive motors for electric vehicles are fabricated in a large size, it is not possible to apply the drive motors to the driving system of the in-wheel motor structure, and it is undesirable in terms of increasing weight of the vehicles.

In general, the amorphous strip has a low eddy current loss, but conventional motor cores that are made of laminated amorphous strips may cause it to be difficult to make a practical application due to difficulties of a manufacturing process as pointed out in the prior art, in view of the nature of the material.

In other words, the amorphous strips provides superior magnetic performance compared to non-oriented electrical steel plates, but are not applied as the bulk magnetic members such as stators or rotors for electric motors because of obstacles that occur during processing for the manufacture.

In addition, the need for improved amorphous metal motor members indicating the excellent magnetic and physical properties required for high-speed, high-efficiency electrical appliances is on the rise. Development of manufacturing methods of efficiently using the amorphous metal and practicing mass-production of a variety of types of motors and magnetic members used for the motors is required.

### SUMMARY OF THE INVENTION

To solve the above problems or defects, it is an object of the present invention to provide an amorphous magnetic component for use in a high-power, high-speed electric motor, in which amorphous metal materials are powdered, compressed, and molded, to thus be easily molded into magnetic components of a complex shape, and crystalline metal powder of excellent soft magnetic properties is added to the amorphous alloy powder, to thus promote improved permeability and improved packing density at the time of compression molding, and a method of manufacturing the amorphous magnetic component.

It is another object of the present invention to provide an amorphous magnetic component for use in a high-power, high-speed electric motor, in which core losses may be minimized by using amorphous powder whose eddy current loss is decreased in a high-frequency band, and a method of manufacturing the amorphous magnetic component.

It is still another object of the present invention to provide a high-power, high-speed electric motor having the number of poles that operate in a frequency band of at least 10 kHz or higher so that permeability properties of amorphous alloy materials can be used at maximum.

It is yet another object of the present invention to provide an electric motor that may be employed in a driving system of an in-wheel motor structure by using a magnetic component made of amorphous alloy powder to thereby minimize the size of the motor.

It is a still yet another object of the present invention to provide an electric motor having a single-stator and single-rotor structure in which divisional cores whose compression molding can be easily done are fabricated by using amorphous alloy powder, the divisional cores are cross-coupled with each other, or the divisional cores are coupled to each other by using bobbins, to thereby implement an annular stator core without increasing magnetoresistance.

To accomplish the above and other objects of the present invention, according to an aspect of the present invention, there is provided a method for making an amorphous magnetic component for electric motors, the method comprising the steps of: pulverizing ribbons or strips of amorphous alloys to thus obtain plate-shaped amorphous alloy powder; classifying the amorphous alloy powder, and then mixing the amorphous alloy powder with spherical soft magnetic powder, to thus obtain mixed powder; mixing the mixed powder with a binder, to then be molded into a shape of the magnetic components; and sintering the molded magnetic components so as to implement magnetic properties.

Preferably but not necessarily, the spherical soft magnetic powder is added in the range of 10% by weight to 50% by weight with respect to the entire mixed powder. Here, in the case that an addition of the spherical soft magnetic powder is less than 10% by weight, an air gap between the amorphous powder becomes large, to thus lower permeability, and increase magnetoresistance of the magnetic component, and to thereby cause a problem of lowering the efficiency of the electric motor, and in the case that an addition of the spherical soft magnetic powder exceeds 50% by weight, a core loss increases, to thus cause a problem of reducing a value of Q (here, Q means a loss factor).

Preferably but not necessarily, an aspect ratio of the plate-shaped amorphous alloy powder is set in the range of 1.5 to 3.5, and an aspect ratio of the spherical soft magnetic powder is set in the range of 1 to 1.2. Here, in the case that the aspect ratio of the plate-shaped amorphous alloy powder is less than 1.5, it takes a long time to pulverize the ribbons or strips of amorphous alloys, and in the case that the aspect ratio of the plate-shaped amorphous alloy powder exceeds 3.5, there is a problem of reducing a packing ratio in a molding process. In addition, it is preferable that the aspect ratio of the spherical soft magnetic powder is set in the range of 1 to 1.2, considering an influence upon improvement of a molding density.

In addition, it is desirable that the amorphous alloy is one of Fe-based, Co-based and Ni-based alloys.

Preferably but not necessarily, the ribbons or strips of amorphous alloys are thermally treated at 400° C. to 600° C. under a nitrogen atmosphere, so as to have a nanocrystalline microstructure.

Preferably but not necessarily, the ribbons or strips of amorphous alloys are thermally treated at a temperature not more than a crystallization temperature, for example, at 100° C. to 400° C. under an air atmosphere, in order to increase pulverization efficiency, and to thereby increase embrittlement of the amorphous alloy ribbons.

Preferably but not necessarily, the spherical soft magnetic powder is one or a mixture of two or more selected from the group consisting of Fe—Si—Al-based alloy (hereinbelow, referred to as Sendust) powder, Ni—Fe-based Permalloy (hereinbelow, referred to as MPP; Moly Permally Powder) powder, Ni—Fe-based Permalloy (hereinbelow, referred to as HighFlux) powder, powder, and Fe-based carbonyl iron powder.

According to another aspect of the present invention, there is provided an electric motor that operates in a high-power, high-speed and high-frequency mode, the electric motor comprising: a stator around a core of which a coil is wound; and a rotor that is disposed with an interval spaced from and in opposition to the stator in which N-pole and S-pole permanent magnets are alternately mounted on a back yoke, and that is rotated by an interaction with the stator, wherein the core and/or the back yoke is molded with mixed powder made of plate-shaped amorphous alloy powder and spherical soft magnetic powder.

As described above, the present invention provides an amorphous magnetic component for use in a high-power, high-speed electric motor, in which amorphous metal materials are powdered, compressed, and molded, to thus be easily molded into magnetic components of a complex shape, and crystalline metal powder of excellent soft magnetic properties is added to the amorphous alloy powder, to thus promote improved permeability and improved packing density at the time of compression molding, and a method of manufacturing the amorphous magnetic component.

In addition, the present invention provides a high-power, high-speed electric motor that is designed to have the number of poles of a rotor that operate in a frequency band of at least 10 kHz or higher so that permeability properties of amorphous alloy materials can be used at maximum.

Further, the present invention provides an amorphous magnetic component for use in a high-power, high-speed electric motor, in which core losses may be minimized by using the magnetic component, that is, a core, made of amorphous alloy powder whose eddy current loss is decreased in a high-frequency band, and as a result, the size of the motor is minimized, so that the amorphous magnetic component may be employed in a driving system of an in-wheel motor structure.

In general, since it is difficult to mutually couple divisional cores with each other without increasing magnetoresistance in a structure of laminating silicon steel plates, it is accordingly difficult to implement an electric motor having a single-stator and single-rotor structure. However, the present invention uses a core made of amorphous alloy powder, to thereby enable the divisional cores to be closely coupled with each other, without increasing magnetoresistance. As a result, the present invention employs the divisional cores even in the single-stator and single-rotor structure, to thus promote efficiency of coil windings and minimize size and weight of the motor.

### BRIEF DESCRIPTION OF THE DRAWINGS

FIG. 1 is an axial cross-sectional view showing an automobile wheel driving device having a shock absorbing function, as an application of a motor including a core of a stator and a back yoke of a rotor in which the core of the stator and the back yoke of the rotor are all molded with amorphous alloy powder according to the present invention.

FIG. 2 is a cross-sectional view diametrically showing a motor including a combination of a divisional core type stator that is configured by using divisional cores molded with amorphous alloy powder and a surface permanent magnet (SMP) type rotor according to a first embodiment of the present invention.

FIGS. 3A and 3B are a plan view and a perspective view of a divisional core molded with amorphous alloy powder according to the present invention, respectively.

FIG. 4 is a schematic view showing that a bobbin is integrally formed with the divisional core shown in FIG. 3A, and a coil is wound on the outer periphery of the bobbin.

FIG. 5 is a cross-sectional view diametrically showing a motor including a combination of an integral core type stator having an integral core molded with amorphous alloy powder, and a surface permanent magnet (SMP) type rotor according to a second embodiment of the present invention.

FIG. 6 is a cross-sectional view diametrically showing a motor including a combination of an integral core type stator having an integral core molded with amorphous alloy powder, and an interior permanent magnet (IMP) type rotor according to a third embodiment of the present invention.

FIG. 7 is a cross-sectional view diametrically showing a motor including a combination of an integral core type stator having an integral core molded with amorphous alloy powder, and an interior permanent magnet (IMP) type rotor according to a modified embodiment of the third embodiment of the present invention.

FIGS. 8A and 8B are a plan view and a side view showing a first gear of a gearbox shown in FIG. 1, respectively.

FIGS. 9A and 9B are a plan view and a side view showing a second gear of a gearbox shown in FIG. 1, respectively.

### DETAILED DESCRIPTION OF THE INVENTION

The objects, features and advantages of the invention will become apparent through the exemplary embodiments that are illustrated in the accompanying drawings and detailed in the following description. Accordingly, the inventive technological concept can be made by those skilled in the art without departing from the spirit and scope of the invention.

In addition, in the description of the present invention, if it is determined that a detailed description of commonly-used technologies or structures related to the invention may unnecessarily or unintentionally obscure the subject matter of the invention, the detailed description will be omitted. Hereinbelow, preferred embodiments of the present invention will be described in detail the with reference to the accompanying drawings.

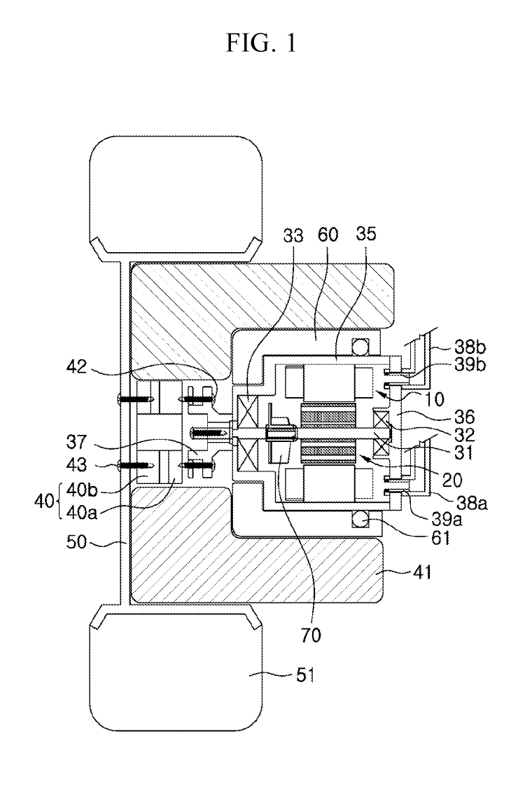

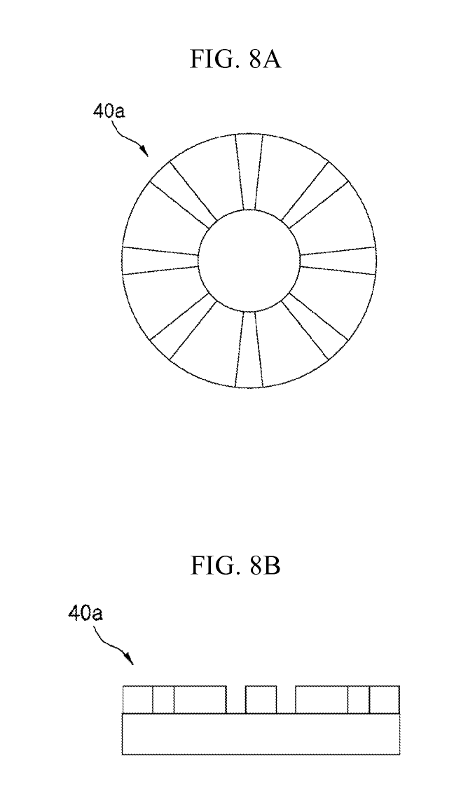

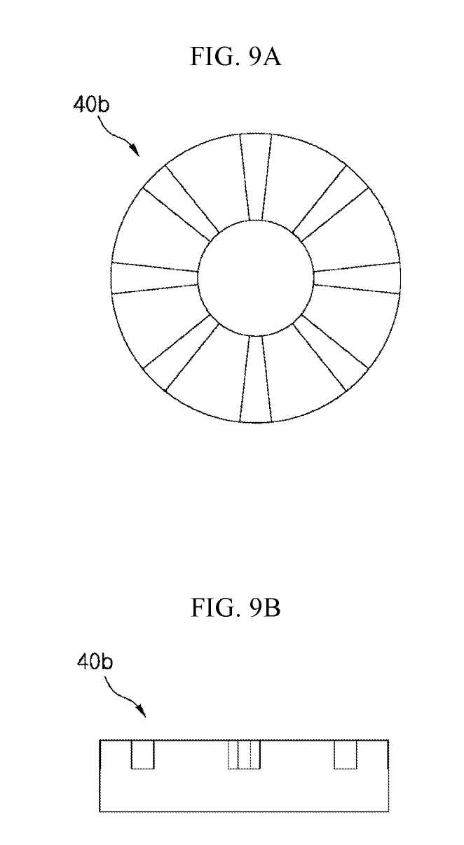

FIG. 1 is an axial cross-sectional view showing an automobile wheel driving device having a shock absorbing function, as an application of a motor including a core of a stator and a back yoke of a rotor in which the core of the stator and the back yoke of the rotor are all molded with amorphous alloy powder according to the present invention. FIGS. 8A and 8B are a plan view and a side view showing a first gear of a gearbox shown in FIG. 1, respectively. FIGS. 9A and 9B are a plan view and a side view showing a second gear of a gearbox shown in FIG. 1, respectively.

As shown in FIG. 1, an automobile wheel driving device (hereinafter, referred to as a “driving device”) having a shock absorbing function is implemented into a structure of buffering a shock via a bumper 41 in which a rotor 10 is not directly connected to a wheel 50, but is connected to the wheel 50 via a gearbox 40, in order to prevent a shock transmitted from the wheel 50 of an electric motor car from being transferred to the rotor 10 or stator 20 of the motor. Here, the motor collectively includes the rotor 10, the stator 20, a stator support, and a rotor support.

The stator 20 of the motor is implemented into a structure in which a bobbin formed of an insulator is integrally formed with an integral core or a divisional core, and then a coil is wound on the bobbin. Here, a stator support may be added to the stator of the motor, in which the stator support is extended to form a coupling structure for integrating the integral core or divisional core and simultaneously coupling the integral core or divisional core with a main body to which a housing or the motor is applied.

The stator support is molded to form a waterproof structure through a BMC (Bulk Mould Compound) insert molding process to thus prevent foreign matters (i.e., water or oil) from incoming from the outside.

In addition, a hall integrated circuit (IC) assembly substrate for detecting position of the rotor 20 and a controlling printed circuit board (PCB) substrate for applying a control signal for the stator coil may be mounted on the stator support.

The rotor 20 of the motor shown in FIG. 1 has an inner rotor structure in which the stator 10 has an air gap in a radial direction and the rotor 20 is disposed in opposition to and in the inside of the stator 10, and is rotated through an interaction with the stator 10.

However, the present invention is not limited thereto, but may be also configured into an outer rotor structure, in which the rotor is placed on the outside of the stator. In addition, the present invention may be also configured into a double rotor structure in which the rotors are placed on the inside and outside of the stator, respectively. Furthermore, the present invention may be, of course, applied to an axial type instead of the radial type in which the rotor and stator are placed in opposition to each other.

In this case, the rotor 20 may employ a surface permanent magnet (SPM) type rotor in which N-pole and S-pole permanent magnets are alternately mounted on an outer circumference of a back yoke, or a ring-shaped permanent magnet where N-pole and S-pole are divisional and magnetized is combined on the outer circumference of the back yoke, or an interior permanent magnet (IPM) type rotor in which N-pole and S-pole permanent magnets are alternately inserted into the inside of the back yoke.

In the case that the present invention employs a double rotor structure, it is also possible to further include a rotor support that interconnects an inner rotor and an outer rotor and is extended to the outer periphery of a rotating shaft 31, so as to be combined with the rotating shaft 31.

In addition, in the case that the rotor is implemented into an inner rotor structure shown in FIG. 1, the present invention may employ a structure that the rotating shaft 31 is combined on a central portion of the back yoke.

In this case, both ends of the rotating shaft 31 are rotatably supported by first and second bearings 32 and 33, respectively. The first and second bearings 32 and 33 are fixed in a motor housing. In addition, a cooling impeller 70 is coupled with the rotating shaft 31 between the second bearing 33 and the rotor 20, and is rotated together during rotation of the rotor 20, to thus generate wind in order to circulate the air inside the motor.

The motor housing includes a cylindrical portion 35 with which the stator 10 is coupled and a cover 36 that is combined on one side of the cylindrical portion 35.

The first bearing 32 is supported in the middle of the cover 36 that is coupled to one side of the cylindrical portion 35, and a groove that is bent in a multi-stage and has a throughhole is formed at the rear of the cylindrical portion 35 so that the second bearing 33 is placed.

At least a pair of nipples 39a and 39b that form at least a pair of openings are combined on the outer circumference of the cover 36 for air-circulation in the inside the motor housing. The nipples 39a and 39b are combined with an external air inlet tube 38a and an internal air discharge pipe 38b, respectively.

Therefore, the rotating shaft 31 and the cooling impeller 70 are rotated together during rotation of the rotor 20, and thus hot air inside the motor housing is discharged to the outside through the internal air discharge pipe 38b, in accordance with the rotation of the cooling impeller 70. As a result, a negative pressure is formed inside the motor housing, and thus cool air is introduced from the outside through the external air inlet tube 38a, thereby cooling the inner portion of the motor.

The motor housing is coupled and fixed to a frame of an automobile car, and a bumper 41 including an accommodating groove that accommodates the motor housing in which the accommodating groove is formed at a central portion of the bumper 41, and a through-hole that is formed at a central portion of the accommodating groove, is combined on an outer circumference of the frame of the automobile car. For example, the bumper 41 is made of a shock absorbing material such as an epoxy material capable of absorbing a shock. A coupling housing 60 that accommodates the motor housing and combines the motor housing with the bumper 41 is inserted into the accommodating groove of the bumper 41. In this case, an O-ring 61 for sealing the inside of the motor housing is inserted between the motor housing and the coupling housing 60.

A coupling 37 is integrally combined on an outer circumference of the rotating shaft 31 that is extended to the outside through the throughhole in the motor housing, in which a flange is formed in the coupling 37 so as to be easily combined with the gearbox 40.

The gearbox 40 that connects between the wheel 50 on the outer circumference of which a tire 51 is combined and the rotating shaft 31 of the motor 31 is placed in the throughhole of the bumper 41, and the gear box 40 includes a first gear 40a that is coupled with the flange of the coupling 37, using coupling members 42, for example, such as bolts, and a second gear 40b that is coupled with the wheel 50, using coupling members 43, for example, such as bolts.

As shown in FIGS. 8A to 9B, the first gear 40a of the gear box 40 includes a plurality of projections that are radially disposed, and the second gear 40b thereof includes a plurality of grooves that are radially disposed so as to be combined with the plurality of projections that are radially disposed in the first gear 40a, respectively. In this case, the rotating shaft of the rotor 31 and the wheel 50 do not transfer a rotational force through a single axis, but transfer the rotational force through a gear coupling structure between the first and second gears 40a and 40b.

In this case, a gap is formed between the first gear 40a and the second gear 40b in the gear box 40, and thus a shock transferred from the wheel 50 is mitigated to then be transferred to the rotor 20 through the rotating shaft 31. The first gear 40a and the second gear 40b in the gear box 40 form a connecting shaft, to thus perform a support shaft function during rotation, and secede from each other through the gap formed therebetween, to thus perform a function of mitigating a shock that is delivered from the wheel 50 to some extent. The first gear 40a and the second gear 40b may employ, for example, crown gears.

In addition, the shock that is applied to the wheel 50 from the tire 51 is transferred to the gear box 40 and the motor housing through the shock absorbing bumper 41, to thus prevent a direct transfer of the shock. The bumper 41 fills an inner space of the wheel 50 with which the tire 51 is combined, to thus form an in-wheel motor structure.

Hereinbelow, a stator and rotor structure to configure the motor according to the present invention will be described in detail.

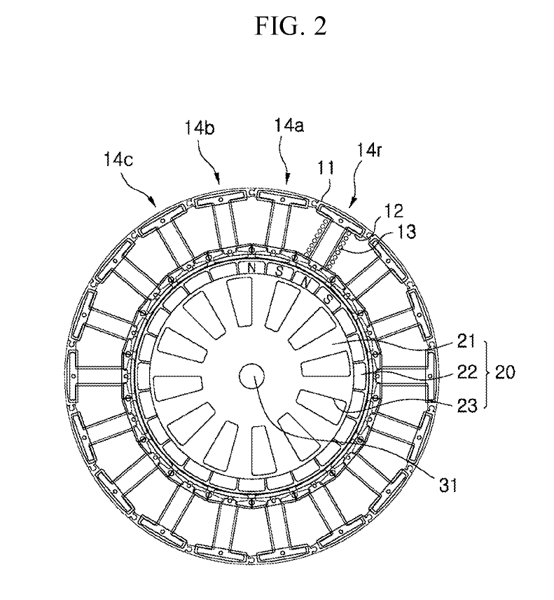

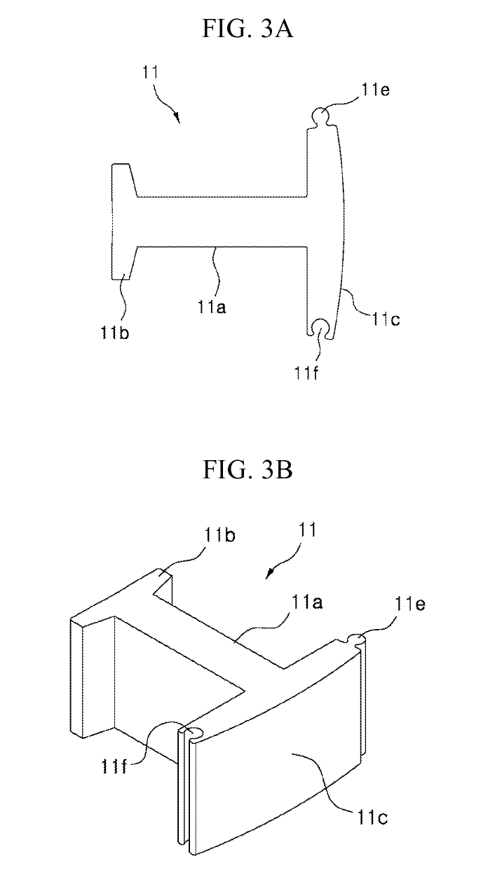

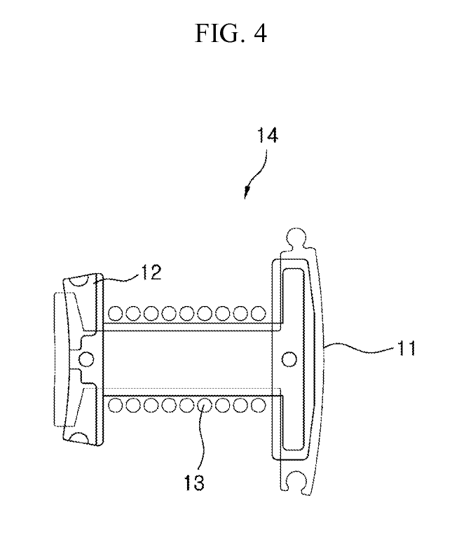

FIG. 2 is a cross-sectional view diametrically showing a motor including a combination of a divisional core type stator that is configured by using divisional cores molded with amorphous alloy powder and a surface permanent magnet (SMP) type rotor according to a first embodiment of the present invention. FIGS. 3A and 3B are a plan view and a perspective view of a divisional core molded with amorphous alloy powder according to the present invention, respectively. FIG. 4 is a schematic view showing that a bobbin is integrally formed with the divisional core shown in FIG. 3A, and a coil is wound on the outer periphery of the bobbin.

Referring to FIGS. 2 to 4, a motor according to a first embodiment of the present invention has a structure of combining a divisional core type stator 10 that is configured by using divisional cores molded with amorphous alloy powder and a surface permanent magnet (SMP) type rotor 20.

The stator 10 of the motor according to the first embodiment of the present invention is configured by assembling a plurality of divisional cores 11 in an annular form, in which each divisional core 11 is molded with amorphous alloy powder, in an “I”-shaped or “H”-shaped form, as shown in FIGS. 3A and 3B. Inner and outer flanges 11b and 11c are extended on both sides of a body 11a placed at the central portion of each divisional core 11, respectively. A coupling projection 11e is formed at one side end of the outer flange 11c and a coupling groove 11f that is coupled with the coupling projection 11e is formed at the other side end of the outer flange 11c, so that the divisional cores 11 are mutually connected with each other.

As shown in FIG. 4, each divisional core 11 is integrally formed with a bobbin 12 formed of an insulator resin, except the inner surfaces and the outer surfaces of the inner and outer flanges 11b and 11c of the divisional core 11, and a coil 13 is wound on the outer circumference of the bobbin 12.

Meanwhile, since the stator shown in FIG. 2 is applied to configure a motor having a single-stator and single-rotor structure, it is necessary to connect between the divisional cores 11 of the stator 10 to form a magnetic circuit. However, in the case of forming a motor having a single-stator and double-rotor structure, a magnetic circuit is not formed by interconnection between the respective divisional cores 11, but is formed between an outer rotor and an inner rotor that oppose each other in the double-rotor structure. Therefore, in this case, instead of interconnecting the outer flanges 11c of the divisional cores 11, an interconnecting structure may be formed on the bobbin 12.

The stator 10 of FIG. 2 is configured by interconnecting and assembling the divisional core assemblies 14 shown in FIG. 4 in an annular form. In other words, a number of divisional core assemblies 14a-14r are assembled in an annular form, by using coupling projections 11e and coupling grooves 11f that are formed in the outer flanges 11c of the divisional cores 11, respectively, and then are integrally formed by an insert molding method using a BMC (Bulk Mould Compound). Otherwise, a number of divisional core assemblies 14a-14r that are assembled in an annular form are fixed by using an assembly annular bracket without using a BMC molding process.

In this case, when the divisional core assemblies 14a-14r that are assembled in an annular form are fixed by using an assembly annular bracket without using a BMC molding process, the stator is fabricated into the light weight, and gaps between the divisional core assemblies 14a-14r are used as paths for air circulation.

In addition, according to the present invention, the divisional cores 11 may be coupled by using coupling projections and coupling grooves that are respectively formed in the bobbins formed on the outer circumferences of the divisional cores 11, instead of using the coupling projections 11e and the coupling grooves 11f that are respectively formed in the outer flanges 11c of the divisional cores 11.

The rotor 20 that is placed on the inside of the stator 10, has a SPM structure that N-pole and S pole permanent magnets 22 are alternately mounted on an outer circumference of a back yoke 21 that is preferably molded with amorphous alloy powder that is the same material as the core of the stator 10.

In this case, a throughhole with which the rotating shaft 31 is coupled, is provided at a central portion of the back yoke 21, and a plurality of throughholes 23 that cool air and reduce the weight of the rotor are arranged in a radial direction between the central portion of the back yoke and the outer circumferential surface thereof.

In the case that the throughholes 23 of the back yoke 21 are applied in a motor for use in an automobile wheel driving device shown in FIG. 1, and thus air inside the motor housing is discharged to the outside through the stator 10, depending on the rotation of the impeller 70, the throughholes 23 of the back yoke 21 play a role of air circulation passages through which external air is introduced and circulated into the inside of the rotor 20.

The present invention may be applied to a case that the divisional cores are implemented to have an integral core structure, other than the stator structure of mutually combining the divisional cores.

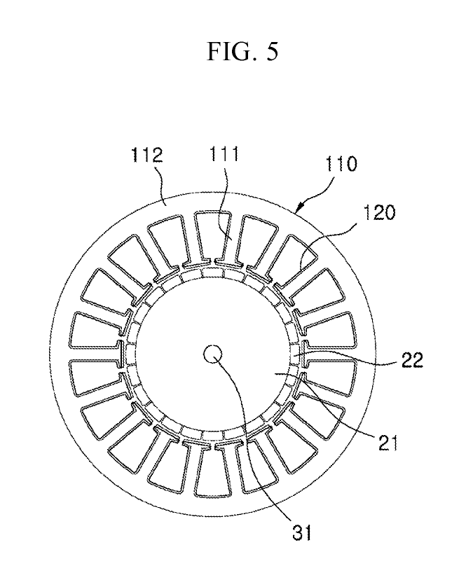

FIG. 5 is a cross-sectional view diametrically showing a motor including a combination of an integral core type stator having an integral core molded with amorphous alloy powder, and a surface permanent magnet (SMP) type rotor according to a second embodiment of the present invention.

As shown in FIG. 5, a motor according to a second embodiment of the present invention includes a stator 10 having an integral core 110 molded with amorphous alloy powder, in which a SPM type rotor 20 of an inner rotor type structure is combined with the integral core type stator. The SPM type rotor 20 has the same structure as that applied to the first embodiment.

The integral core 110 that is adopted in the second embodiment has a structure that a number of teeth 111 are extended to and formed in the inner side of an annular back yoke 112. Bobbins 120 are integrally formed on the teeth 111, respectively, in which each bobbin 120 is made of an insulating material for insulation of a coil wound on the teeth 111.

Meanwhile, the motor according to the present invention may be implemented by employing an interior permanent magnet (IPM) type rotor, as the rotor structure, instead of employing the SPM type rotor 20 disclosed in the first and second embodiments.

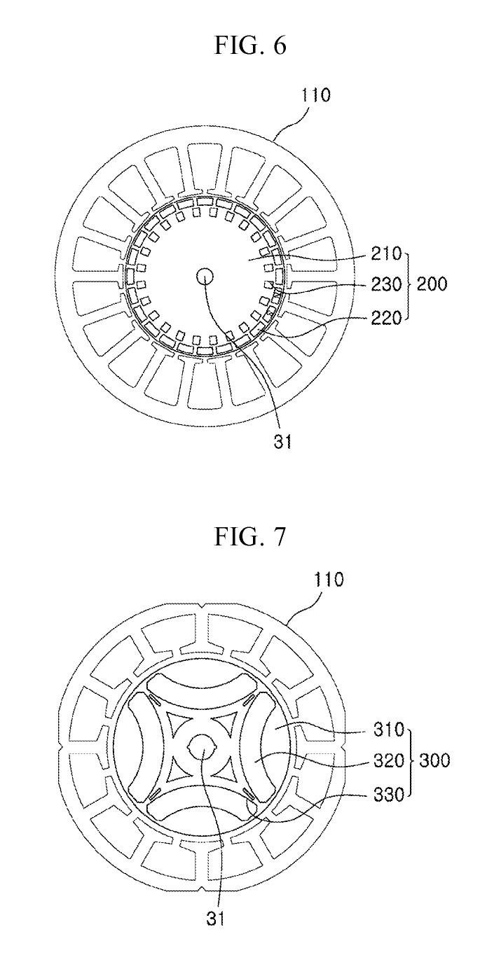

FIG. 6 is a cross-sectional view diametrically showing a motor including a combination of an integral core type stator having an integral core molded with amorphous alloy powder, and an interior permanent magnet (IMP) type rotor according to a third embodiment of the present invention.

As shown in FIG. 6, an IPM type rotor of a motor according to a third embodiment of the present invention has a structure having a plurality of throughholes formed on an identical circumference adjacent to the outer circumferential surface of a back yoke 210, in which N-pole and S-pole permanent magnets 220 are alternately arranged in an annular form in the throughholes, respectively. The permanent magnets 220 has a respectively rectangular cross-sectional form of a bar shape.

In addition, caps are respectively combined on both ends of the back yoke 210, to prevent secession of the permanent magnets 220 and a rotating shaft 31 is combined at a central portion of the back yoke 210.

In addition, a number of throughholes 230 that block leakage magnetic flux and play a role of air circulation passages, between the permanent magnets 220, are disposed on an identical circumference located inwards from between the permanent magnets 220.

In this case, the stator applied to the third embodiment, indicates use of the integral core 110, but the stator 10 that is formed by assembling a number of divisional cores 11 may be used.

FIG. 7 is a cross-sectional view diametrically showing a motor including a combination of an integral core type stator having an integral core molded with amorphous alloy powder, and an interior permanent magnet (IMP) type rotor according to a modified embodiment of the third embodiment of the present invention.

The IPM type rotor of the motor shown in FIG. 7 include four permanent magnets 320 that are inserted on the outside side of a back yoke 310, in which four throughholes 330 that block leakage magnetic flux and play a role of air circulation passages, are disposed among the four permanent magnets 320, respectively.

The permanent magnets 320 of FIG. 7 differ from the permanent magnets 220 of the IPM type rotor of FIG. 6, in the point that the permanent magnets 320 of FIG. 7 have cross-sectional shapes with a rounded form, respectively.

Hereinbelow, a method for manufacturing magnetic components such as a core of a stator and a back yoke of a rotor that form magnetic circuits in the respective motors according to the first to third embodiments of the present invention will be described.

The magnetic components according to the present invention are obtained by molding amorphous alloy powder obtained through a process of fabricating an ultra-thin type amorphous alloy of 30 μm or less in a ribbon or strip form by using a rapid solidification processing (RSP) method through a melt spinning process, and then pulverizing the ultra-thin type amorphous alloy of the ribbon or strip form. Here, the obtained amorphous alloy powder has a size in the range of 1 to 150 μm.

The amorphous alloy powder is classified into amorphous alloy powder with an average powder particle size of 20 to 50 μm, and amorphous alloy powder with an average powder particle size of 50 to 75 μm, through a classification process. Preferably, amorphous alloy powder that is mixed at a weight ratio of 1:1 is used. Here, an aspect ratio of the obtained amorphous alloy powder is preferably set in the range of 1.5 to 3.5.

In this case, the amorphous alloy ribbons or strips may be heat-treated at 400-600° C. in the air or under a nitrogen atmosphere, so as to have a nanocrystalline microstructure that can promote high permeability before or after pulverization.

In addition, the amorphous alloy ribbons or strips may be heat-treated at 100-400° C. in the air, to improve the pulverization efficiency.

For example, any one of a Fe-based, Co-based, and Ni-based amorphous alloy may be used as the amorphous alloy. Preferably, a Fe-based amorphous alloy is advantageous in terms of price. A Fe-based amorphous alloy is preferably any one of Fe—Si—B, Fe—Si—Al, Fe—Hf—C, Fe—Cu—Nb—Si—B, and Fe—Si—N. In addition, a Co-based amorphous alloy is preferably any one of Co—Fe—Si—B and Co—Fe—Ni—Si—B.

Thereafter, the pulverized amorphous alloy powder is classified depending on the size of the particle, and then mixed in a powder particle size distribution having optimal composition uniformity. In this case, since the amorphous alloy powder is made up in a plate shape, a packing density is lowered when the amorphous alloy powder is mixed with a binder to then be molded into a shape of components. Accordingly, the present invention uses a mixture of a predetermined amount of spherical soft magnetic powder with plate-shaped amorphous alloy powder, to thus increase the packing density, in which the spherical soft magnetic powder is made of spherical powder particles, to promote improvement of magnetic properties, that is, permeability.

The spherical soft magnetic powder is preferably added in the entire mixed powder in the range of 10 to 50% by weight (wt %), and an aspect ratio of the spherical soft magnetic powder is preferably set in the range of 1 to 1.2, considering an influence upon improvement of the packing density.

For example, MPP powder, HighFlux powder, Sendust powder, and iron powder may be used as the spherical soft magnetic powder that may promote improvement of the permeability and the packing density. One or a mixture of two more of MPP powder, HighFlux powder, Sendust powder, and iron powder may be used as the spherical soft magnetic powder.

The spherical soft magnetic powder mixed in the amorphous alloy powder is mixed with a binder. For example, thermosetting resins such as sodium silicate called water glass, ceramic silicate, an epoxy resin, a phenolic resin, a silicone resin or polyimide may be used as a binder to be mixed. In this case, the maximum mixing ratio of the binder is preferably 20 wt %.

The mixed amorphous alloy powder is compressed and molded into a desired shape of cores or back yokes by using presses and molds at a state where binders and lubricants have been added in the amorphous alloy powder. In this case, a molding pressure is preferably set to 15-20 ton/cm².

After that, the molded cores or back yokes are sintered in the range of 300-600° C. for 10-600 min to implement magnetic properties.

In the case that the heat-treatment temperature is less than 300 ° C., heat treatment time increases to thus cause a loss of productivity, and in the case that heat-treatment temperature exceeds 600° C., deterioration of the magnetic properties of the amorphous alloys occurs.

As described above, in the present invention, amorphous alloy materials are powdered, compressed, and molded, to thus be easily molded into magnetic components of a complex shape, such as a core of a stator and a back yoke of a rotor, and crystalline metal powder of excellent soft magnetic properties is added to the amorphous alloy powder, to thus promote improvement of a magnetic permeability and improvement of a packing density at the time of compression molding.

The embodiments of the present invention will be described in more detail. However, the embodiments are nothing but examples of the present invention, and the scope of the present invention is not limited thereto.

### EXAMPLE 1

Amorphous alloy ribbons of a composition Fe₇₈—Si₉—B₁₃ prepared by a melt spinning process were heat-treated at 300° C. in the air for one hour, to thus obtain preliminarily heat-treated amorphous alloy ribbons. The amorphous alloy ribbons were pulverized with a crusher, to thus obtain amorphous alloy powder, and then the amorphous alloy powder was classified into amorphous alloy powder with an average powder particle size of 20 to 50 μm, and amorphous alloy powder with an average powder particle size of 50 to 75 μm, through classification and weighing processes, to thus obtain a mixture of powder mixed at a ratio of 50% by weight of the amorphous alloy powder with an average powder particle size of 20 to 50 μm and 50% by weight of the amorphous alloy powder with an average powder particle size of 50 to 75 μm. Here, an aspect ratio of the obtained amorphous alloy powder was in the range of about 1.5 to 3.3.

Fe—Si—Al-based Sendust powder was mixed with amorphous alloy powder, to thus a mixture of the powder, while varying an amount of added Fe—Si—Al-based Sendust powder up to 70 wt %, as soft magnetic powder to be added in order to improve a permeability and improve a packing density at the time of compression molding. An average particle size of the added Sendust powder was 4.4 μm, and an aspect ratio was an average of 1.1.

Then, the prepared mixed powder was mixed with 1.5 wt % of phenol, to then have carried out a dry process. The agglomerated powder after drying was pulverized again by using a ball mill, then mixed with 0.5 wt % of zinc stearate, and was compressed and molded using a mold, at a molding pressure of 20 ton/cm², to thus have obtained a core of a stator. Afterwards, the molded cores were sintered and maintained at a temperature of 450° C., for 30 minutes, and then a packing ratio η(%), an effective cross-sectional area A′, a permeability μ, and a Q (loss factor) characteristic for a core were measured, and shown in Table 1.

The packing ratio η(%) was expressed as a percent ratio of a mass that can be ideally filled in a volume calculated in an actually manufactured mold and an actually measured mass. The effective cross-sectional area was a cross-sectional area A′ in which magnetic powder was filled, and was obtained by a multiplication of an ideal cross-sectional area A and the packing ratio η(%).

The permeability μ was obtained by measuring an inductance L at a frequency f (=10 kHz) and then calculated with the measured variables, and because of the shape of the measured sample, a Q value of a core loss (P_{C}) was not directly measured in a core loss measuring meter but the Q value was calculated using Equation 1.

Q=1/(P_{C}×μ) [Equation 1]

TABLE 1

| Amount of | | Effective | | |
|---|---|---|---|---|
| added soft | | cross-sectional | | |
| magnetic | Packing | area | Permeability | |
| powder (wt %) | ratio η(%) | (A′) | (μ) | Q |
| — | 80.5 | 0.805 × A | 40.5 | 26.6 |
| 10 | 81.2 | 0.812 × A | 41.5 | 19.9 |
| 20 | 82.5 | 0.825 × A | 43.0 | 16.2 |
| 30 | 83.4 | 0.834 × A | 48.2 | 12.5 |
| 40 | 84.3 | 0.843 × A | 52.0 | 11.5 |
| 50 | 85.6 | 0.856 × A | 54.0 | 10.0 |
| 60 | 86.4 | 0.864 × A | 54.1 | 8.9 |
| 70 | 87.2 | 0.872 × A | 55.1 | 8.46 |

As shown in Table 1, as an amount of added soft magnetic powder increases, the packing ratio η(%) and the effective cross-sectional area A′ increased and the permeability also increased.

In addition, as shown in Table 1, it can be seen that as an amount of added soft magnetic powder increased, the Q values indicated a decreasing tendency and when the Q values increased, the core loss decreased according to Equation 1.

Therefore, an amount of added soft magnetic powder is preferably in the range of 10 to 50 wt %, when considering both the minimum permeability and the maximum allowable core loss value that are required for the magnetic components.

### EXAMPLE 2

Amorphous alloy ribbons of a composition Fe₇₃₅—Cu₁—Nb₃—Si₁₃₅—B₉ prepared by a melt spinning process were heat-treated at 540° C. under a nitrogen atmosphere for 40 min, to thus obtain nanocrystalline ribbons. The nanocrystalline size was in the range of 10 to 15 nm. The nanocrystalline ribbons were pulverized with a crusher to obtain nanocrystalline alloy powder, and then the nanocrystalline alloy powder was classified into nanocrystalline alloy powder with an average powder particle size of 20 to 50 μm, and nanocrystalline alloy powder with an average powder particle size of 50 to 75 μm, through classification and weighing processes, to thus obtain a mixture of powder mixed at a ratio of 50% by weight of the nanocrystalline alloy powder with an average powder particle size of 20 to 50 μm and 50% by weight of the nanocrystalline alloy powder with an average powder particle size of 50 to 75 μm. Here, an aspect ratio of the obtained nanocrystalline alloy powder was in the range of about 1.5 to 3.3.

30% by weight of Fe—Si—Al-based Sendust powder was added to and mixed with nanocrystalline alloy powder, to thus a mixture of the powder, as soft magnetic powder to be added in order to improve a permeability and improve a packing density at the time of compression molding. An average particle size of the added Sendust powder was 4.4 μm, and an aspect ratio was an average of 1.1.

Then, the prepared mixed powder was mixed with 3 wt % of low melting point glass, to then have dried and coated the agglomerated powder after drying in a manner of pulverizing the agglomerated powder again by using a ball mill, then mixed with 0.5 wt % of zinc stearate, and was compressed and molded using a mold, at a molding pressure of 16 ton/cm², to thus have obtained a core of a stator.

Afterwards, the molded cores were sintered and maintained at a temperature of 450° C., for 30 minutes, and then a packing ratio η(%), an effective cross-sectional area A′, a permeability μ, and a Q (loss factor) characteristic for a core were measured, and shown in Table 2.

TABLE 2

| Amount of added | | Effective | | |
|---|---|---|---|---|
| soft magnetic | | cross-sectional | | |
| powder | Packing | area | Permeability | |
| (wt %) | ratio η(%) | (A′) | (μ) | Q |
| — | 80.5 | 0.805 × A | 48.0 | 82.0 |
| 10 | 81.2 | 0.812 × A | 48.2 | 58.9 |
| 20 | 82.5 | 0.825 × A | 52.4 | 48.6 |
| 30 | 83.4 | 0.834 × A | 60.0 | 37.5 |
| 40 | 84.3 | 0.843 × A | 62.0 | 34.5 |
| 50 | 85.6 | 0.856 × A | 62.6 | 30.0 |
| 60 | 86.4 | 0.864 × A | 63.1 | 26.7 |
| 70 | 87.2 | 0.872 × A | 63.5 | 22.4 |

As can be seen from Table 2, the permeability in Example 2 further increased than in Example 1, and as the Q value increased, the core loss was reduced greatly.

Meanwhile, when an amorphous alloy material is made to operate at a frequency band of at least 10 kHz or higher, the permeability characteristics may be used at maximum. Taking this into consideration, in the present invention, the number of poles for the rotor 10 of the motor is set as shown in Equation 2.

F=P×N/120 [Equation 2]

Here, F represents a rotational frequency, P the number of poles of the rotor, and N the rpm of the rotor.

Assuming that a motor operates at 50,000 rpm at a rotational frequency of 10 kHz, in the present invention, the number of desired poles is obtained as 24 poles. The rotor 20 or 200 respectively disclosed in the first to third embodiments is designed to have a 24-pole structure, and the motor is designed to have a 24-pole-18-slot structure.

In the present invention, the back yoke used for the rotor 20 or 200 of the motor and the core 11 used for the stator 10 of the motor are prepared by sintering the amorphous alloy powder, thereby minimizing a core loss and at the same time optimizing the number of poles of the rotor in an operating frequency band of 10 kHz or higher, at the time of designing and thereby maximizing the permeability characteristics.

Thus, even if the electric motor according to the present invention is applied for a drive system for electric vehicles which require a high output of 100 kW or larger, it is possible to employ the electric motor according to the present invention for an in-wheel motor structure drive system, since the electric motor according to the present invention may be implemented into a miniaturized size.

In addition, the electric motor according to the present invention may be applied to driving devices for electric vehicles as well as to driving devices for hybrid type electric vehicles (HEV).

Furthermore, the electric motor according to the present invention may be applied as a generator.

As described above, the present invention has been described with respect to particularly preferred embodiments. However, the present invention is not limited to the above embodiments, and it is possible for one who has an ordinary skill in the art to make various modifications and variations, without departing off the spirit of the present invention. Thus, the protective scope of the present invention is not defined within the detailed description thereof but is defined by the claims to be described later and the technical spirit of the present invention.

The present invention is molded with a mixture of powder made of plate-shaped amorphous alloy powder and spherical soft magnetic powder, and applied for amorphous magnetic components that are used for high-power, high-speed electric motors for electric vehicles, for example, a core of a stator and/or a back of a rotor.

What is claimed is:

1. A method for making an amorphous magnetic component for electric motors, the method comprising the steps of:
pulverizing ribbons or strips of amorphous alloys to thus obtain plate-shaped amorphous alloy powder;
classifying the amorphous alloy powder, and then mixing the amorphous alloy powder with spherical soft magnetic powder, to thus obtain mixed powder;
mixing the mixed powder with a binder, to then be molded into a shape of the magnetic components; and
sintering the molded magnetic components so as to implement magnetic properties.

2. The method of claim 1, wherein the spherical soft magnetic powder is added in the range of 10% by weight to 50% by weight with respect to the entire mixed powder.

3. The method of claim 1, wherein an aspect ratio of the plate-shaped amorphous alloy powder is set in the range of 1.5 to 3.5, and an aspect ratio of the spherical soft magnetic powder is set in the range of 1 to 1.2.

4. The method of claim 1, wherein the ribbons or strips of amorphous alloys are thermally treated at 400° C. to 600° C. under a nitrogen atmosphere, so as to have a nanocrystalline microstructure.

5. The method of claim 1, wherein the ribbons or strips of amorphous alloys are thermally treated at 100° C. to 400° C. under an air atmosphere, in order to increase pulverization efficiency.

6. The method of claim 1, wherein the spherical soft magnetic powder is one or a mixture of two or more selected from the group consisting of MPP powder, HighFlux powder, Sendust powder, and iron powder.

7. The method of claim 1, wherein the binder is a thermosetting resin, including sodium silicate (that is, water glass), ceramic silicate, an epoxy resin, a phenolic resin, a silicone resin or polyimide.

8. The method of claim 1, wherein the sintering takes place in the range of 300-600° C. for 10-600 min.

9. The method of claim 1, wherein the magnetic component is at least one of a core of a stator and a back yoke of a rotor in the electric motors.

10. An amorphous magnetic component manufactured according to claim 1.

11. An electric motor that operates in a high-power, high-speed and high-frequency mode, the electric motor comprising:
a stator around a core of which a coil is wound; and
a rotor that is disposed with an interval spaced from and in opposition to the stator in which N-pole and S-pole permanent magnets are alternately mounted on a back yoke, and that is rotated by an interaction with the stator,
wherein the core and/or the back yoke is molded with mixed powder made of plate-shaped amorphous alloy powder and spherical soft magnetic powder.

12. The electric motor according to claim 11, wherein the stator core is formed of a divisional core or an integral core.

13. The electric motor according to claim 11, wherein the stator core is formed of a number of divisional cores and the respective divisional cores are annularly mutually coupled with each other, by using coupling protrusions and coupling grooves that are formed on both side ends of an outer flange.

14. The electric motor according to claim 11, wherein the stator core is formed of a number of divisional cores and the respective divisional cores are annularly mutually coupled with each other, by using bobbins that are formed on the respective divisional cores.

15. The electric motor according to claim 11, wherein the amorphous alloy powder and the soft magnetic powder is mixed at a weight ratio in the range of 5:5 to 9:1.

16. The electric motor according to claim 11, wherein the rotor has the number of poles P, which is determined by the following equation P=F/N×120, in which a rotational frequency is F, and rpm of the rotor is N.

17. The electric motor according to claim 11, wherein the rotor of the motor is a single-rotor type or a double-rotor type.
